(19) United States
(12) Patent Application Publication
(10) Pub. No.: US 2002/0085744 A1
(43) Pub. Date: Jul. 4, 2002

(54) Evaluation of microscope slides

(75) Inventors: Richard A. Domanik, Libertyville, IL (US); L. Nicolas Bernier, La Ravoire (FR)

Correspondence Address: MERCHANT & GOULD PC, P.O. BOX 2903, MINNEAPOLIS, MN, 55402-0903, US

(73) Assignee: MOLECULAR DIAGNOSTICS, INC., Chicago, IL (US)

(21) Appl. No.: 09/989,081

(22) Filed: Nov. 19, 2001

Related U.S. Application Data
(60) Provisional application No. 60/249,700, filed on Nov. 17, 2000.

(51) Int. Cl. G06K 9/00

(52) U.S. Cl. 382/133

(57) ABSTRACT

An effective and convenient means exists for registering and correlating two or more microscopic images without imposing unusually stringent requirements of accuracy, precision and resolution on the microscope system. Particular utility is found in examining cervical cell samples.

### RELATED APPLICATION

This application claims the benefit of U.S. Provisional Application Serial No. 60/249,700, entitled “METHOD FOR SCREENING AND EVALUATING MICROSCOPE SLIDES”, filed Nov. 17, 2000; which application is incorporated in its entirety by reference herein.

### TECHNICAL FIELD

The invention relates generally to methods of screening slides with a microscope and relates more specifically to a methodology whereby two successive observations of a slide are interrupted by removal and replacement of the slide.

### BACKGROUND

A routine cytology practice is to treat a specimen with an immunofluorescent reagent that selectively stains or labels some particular cellular feature prior to a first observation; and then to counterstain the specimen with a reagent such as hematoxylin or a Pap stain that permits the identification of the cellular objects on the specimen prior to a second observation. The results of the two observations can be correlated to identify the cellular objects that were labeled by the immunofluorescent reagent.

The first observation can include measuring the fluorescent intensity or fluorescent intensity distribution that results from treatment of the specimen with the immunofluorescent reagent. Correlating these measurements with the identifications obtained during the second observation allows one to determine the level of immunofluorescent staining associated with each cell type present in the specimen.

Thus, it can be beneficial to correlate the results obtained from two successive observations of a specific region of a specimen or slide under circumstances where it is necessary remove the specimen from the microscope; perform some operation on the specimen; and return the specimen to the microscope between the two observations. In this discussion, the terms slide and specimen are employed interchangeably.

Although the process described above is conceptually simple, the correlation of objects between the first and second observations can be very challenging. One common attempt at resolving these difficulties is to record the locations of the objects of interest detected in the first observation and to return to these same locations prior to making the second observation. In theory, the locations in question can be expressed in terms of stage coordinates referred to some reference point such as one corner of the specimen.

In practice, however, establishing unambiguous correlation between objects in the two observations is frequently a difficult task, as this methodology assumes that when the specimen is returned to the stage prior to the second observation, it is returned in exactly the same position and orientation that it had during the first observation. This assumption is dubious at best, as there are a number of possible interfering factors.

One of the more common interfering factors when observing specimens mounted on microscope slides is related to the interface between the slide and the microscope. Most microscopes have a mechanical gripping device to bias the slide against three precision locating pads that are part of the microscope structure. While this type of slide positioning/retaining device is quite adequate for many applications, it is usually not adequate in applications such as described above.

A major source of error comes from the fabrication of a typical microscope slide, as most microscope slides have rough edges. When a slide is biased against the microscope locating pads, contact between the slide and the pads will be at the points on the slide edges that protrude furthest from the body of the slide. If such a slide is replaced in the gripping mechanism, there is no guarantee that the same protuberances will contact exactly the same points on the locating pads. Furthermore, protuberances on the slide may break, crush or chip during installation or handling, thus modifying the manner in which the slide seats against the gripper. Similarly dirt or other debris may become lodged between the edge of the slide and the contact points on the gripper. Such changes in contact geometry are reflected in a change in the position of the slide relative to the coordinate system of the stage. Both lateral and rotational shifts can occur. Even though these shifts are small in magnitude, they are significant when the positioning tolerances for an object on the slide are less than a few microns, a typical requirement in correlation studies such as described above.

The nature of the experiment being performed and the nature of the specimen itself can also have a major impact on correlation between two observations. Assume, for example, that the location of a single cell was recorded during the first observation and that the second observation revealed that this cell was one member of a dense packed uniform sheet of similar cells. Under these circumstances, even a small composite repositioning error can render suspect the correlation of the cell of the first observation with any specific cell in the second observation. If the repositioning error exceeds one half of the mean cell diameter, the correlation fails entirely. A more common situation is where the cells of the second observation are of various sizes and shapes and are overlapped to varying degrees. Establishing a reliable correlation under these conditions is even more problematical.

An analogous situation occurs when a sub-cellular organelle or structure is fluorescently labeled prior to the first observation. In most cases, this fluorescent organelle or structure appears in the first observation as a relatively undifferentiated “blob” of light. The identity of the organelle or structure underlying this blob is made by correlating the recorded location of the blob with cellular features appearing in the second observation. In this case, a repositioning error of far less than cellular dimensions can render this correlation meaningless.

Another analogous situation occurs when the undifferentiated fluorescent blob of the first observation extends over portions of multiple cells in the second observation and it is desired to quantitatively determine the individual contributions of each of the underlying cells to the fluorescence of the first observation. Again, even a small repositioning error can have a substantial impact upon the experimental results. The situation becomes even more complex when it is desired to correlate multiple objects between the two observations.

Another source of complication arises from the manner in which the observations to be correlated are presented to the user. The locations recorded in the first observations may, for example, be presented to the user in the form of a crosshair reticle in the microscope eyepiece that is optically superimposed on the second observation. Although the object in the first observation has dimension, it is effectively represented in the second observation as a point. Numerous factors render all but the grossest correlations made in this manner suspect.

Another common practice is to capture the image of, for example, fluorescent objects in the first observation and display this image to the user on some form of video monitor while the second observation is being made through the microscope eyepieces. This sort of arrangement requires that the user divide their attention between the monitor and the eyepieces while mentally correlating the two images.

Many other factors that affect the correlation between two observations can similarly be described. These factors, singly or in combination, render correlations between two observations under the conditions described above difficult and frequently suspect. Thus, a desire remains for effective and convenient means for registering and correlating two or more microscopic images.

### SUMMARY

Accordingly, the present invention is directed toward providing an effective and convenient means for registering and correlating two or more microscopic images without imposing unusually stringent requirements of accuracy, precision and resolution on the microscope system.

Accordingly, an embodiment of the present invention is found in a method of correlating a first microscope observation with a second microscope observation. A first microscope observation is captured to form a first image and a second microscope observation is captured to form a second image. A microscope observation can be defined as what is actually observed under the microscope. Capturing a microscope observation to form an image can be defined as translating a visual observation into a digital or otherwise electronic version of that visual observation.

Two or more points are selected on the first image and two or more corresponding points are selected on the second image. A transformation based on the selected points is calculated in order to align the first and second images, and the second image is therefore transformed to align the first image with the second image.

Another embodiment of the present invention is found in a process for examining cervical cell samples. A cervical sample bearing a first reagent is placed on a microscope slide and the slide is placed on a microscope. A first image of the cervical sample is captured, followed by removing the cervical sample from the microscope in order to provide a second reagent. The cervical sample is then returned to the microscope, and a second image is captured. Then, the first and second images are reconciled.

Other features and advantages of the present invention will be apparent from the following detailed description and drawings.

### BRIEF DESCRIPTION OF THE FIGURES

FIG. 1 is a flowchart broadly illustrating a method for correlating two microscope observations in accordance with an embodiment of the present invention.

FIG. 2 is a flowchart illustrating a process for examining cervical cell samples in accordance with an embodiment of the present invention.

FIGS. 3-4 are a flowchart illustrating a process for examining cervical cell samples in accordance with an embodiment of the present invention.

### DETAILED DESCRIPTION

The invention is found in a method of correlating a first microscope observation with a second microscope observation in which a first microscope observation is captured to form a first image and a second microscope observation is captured to form a second image. Two or more points on each of the first image and the second image are selected and are used to calculate a transformation. A transformation is then performed in order to align the first image with the second image.

In particular, a user can select the two or more points on the first image and the two ore more corresponding points on the second image that are used in the transformation.

If desired, the method can include an optional step of performing shading corrections on the first image. A step of locating possible objects of interest in the first image can be performed, followed by obtaining position information for any possible objects of interest. This can include centroid information, as well as skeletonizing each object by retaining the boundaries of each object while setting the interior of the object to a threshold value. Once the second image has been captured, shading corrections can be performed if desired. The second image can then be segmented to locate objects of interest. The segmented second image can be used to segment the first image.

In particular, each of the first microscope observation and the second microscope observation can include viewing a cervical cell sample. The cervical cell sample can be treated with an immunofluorescent reagent that has been selected to identify a particular cellular feature. The immunofluorescent reagent can be applied to the sample during or after the initial preparation of a microscope slide. The cervical cell sample can subsequently be treated with a counterstaining reagent that has been selected to identify cellular objects.

In the process of capturing each of the first and second images, a thresholding step can be included in which the raw data from the camera is filtered. In a particular process, any pixels with a value less than a threshold value can be set equal to zero. Pixels with a value equal to or greater than the threshold value can be left unchanged. Alternatively, any pixels with a value greater to or equal to the threshold value can be set equal to one. The resultant data is in binary form, with all pixels set equal to either zero or one.

The invention is also found in a process for examining cervical cell samples in which a cervical sample is placed on a microscope slide and is contacted with a first reagent. The slide is placed on a microscope and a first image of the cervical sample is captured. The slide is removed from the microscope so that a second reagent can be applied and is then returned to the microscope. A second image of the cervical sample is captured and the first and second cervical sample images are reconciled.

Reconciling the first and second images can include selecting two or more points on the first image and two or more corresponding points on the second image, calculating a transformation based on the selected points to align the first and second images, and transforming the second image to align the first image with the second image. If desired, the second image can be segmented to form a segmented second image which can then be used to segment the first image. The step of selecting two ore more points on the first image and locating two or more corresponding points on the second image can be carried out manually by an operator.

The cervical sample can include an immunofluorescent reagent. A counterstaining reagent can subsequently be added. Shading corrections can optionally be performed on the first image, followed by locating possible objects of interest in the first image. Positioning data such as centroid information for the possible objects of interest can be obtained, followed by an optional step of skeletonizing each possible object of interest.

The second image can be shade corrected if desired or necessary, followed by segmenting the second image to form a segmented second image that can then be used to segment the first image. If desired, a thresholding step can be included in which the raw data is filtered. In a particular process, any pixels with a value less than a threshold value can be set equal to zero. Pixels with a value equal to or greater than the threshold value can be left unchanged. Alternatively, any pixels with a value greater to or equal to the threshold value can be set equal to one. The resultant data is in binary form, with all pixels set equal to either zero or one.

The microscope described herein can include a computer controlled motorized stage, a video camera, a “frame grabber” or similar means of capturing the output of the camera and communicating it to the computer, and a display device upon which both video images captured by the camera and information generated by the computer can be presented to an operator. The details of this system will be determined by the requirements of the particular application at hand. Examples of suitable microscopes are described in U.S. Pat. Nos. 6,151,161; 6,148,096; 6,091,842; and 6,026,174; which disclosures are incorporated in their entirety by reference herein.

The invention can be summarized in the non-limiting context of correlating a first observation of a fluorescently stained specimen with a second observation of the same specimen stained with a Pap reagent.

The specimen is mounted on the microscope stage and the specimen is brought into focus. The stage can be commanded to move the specimen such that a field of view containing objects of interest is visible though the eyepieces (or on a display of the corresponding camera image). An image of this field of view can be captured from the video camera, transferred to the computer, and optionally stored for future reference. A shading correction operation can be applied to the captured image either before storage or subsequent processing to compensate for spatial variations in illumination, the optical transfer function, camera response and similar factors. Procedures for shading correction are well known in the art, although such corrections are merely preferred, not required.

A thresholding or other algorithm for determining the boundaries of the objects appearing in the field of view can be applied to a copy of the image. Such algorithms are well known in the art. A histogram-based adaptive thresholding algorithm can be used to compensate for field to field variations in specimen illumination and/or average optical density. The thresholding algorithm is structured to set all pixels having values that are less than the threshold to the value of zero while leaving the values of the other pixels in the image unchanged.

For convenience, this operation can be performed in two stages, i.e., generating a binary representation of the image based upon the threshold value and using this binary representation as a mask that is logically combined with the original image in such a manner as to suppress all pixels having values below the threshold. Both the binary and masked representations of the original image are stored for later use. Specifically, the binary representation is retained for use as described below while the masked image is retained for optional quantitation and other measurements that depend upon the particular experiment being performed.

This binary image can include juxtaposed “black” and “white” regions in which, the pixel values are “1” or “0”, respectively. In this convention, the pixels having values greater than or equal to the threshold are represented as “black”. The centroid of each of the black regions is computed and combined with positional information from the microscope stage to determine the location of each black region relative to the microscope coordinate system. Location measures other than centroid can also be used. The boundaries between the black and white areas of the image can be reduced to a line that is one pixel wide by the application of a skeletonizing algorithm. Both the boundary and location information for each black region are stored for use as described below.

Once all relevant initial images have been captured and processed, the slide can be removed for secondary processing and returned to the microscope stage. The specimen is then repositioned at the recorded coordinates of a field of view of interest, the corresponding skeletonized image is retrieved from storage; an image of the current field of view is captured; and both the new and skeletonized images are displayed on a monitor in superimposed form. Each of these two images is maintained as an independent layer in display space to facilitate subsequent manipulations.

At this point, the current and skeletonized images may, but generally will not be in register. If the latter is the case, the computer mouse or other positioning device can be used to mark a location on the current image and the corresponding location on the skeletonized image. The marked location in the current image can be an image feature that is also apparent in the skeletonized image. When both points are marked, the stage position is changed under computer control to bring the marked point on the current image into coincidence with the corresponding point on the skeletonized image. A second pair of points is then similarly marked on both images.

The software algorithm controlling the stage can use the information from the first and second pairs of points to compute a mathematical transformation that when applied to the skeletonized image will cause the skeletonized image to be translated, rotated and scaled such that the second pair of points becomes superimposed while the first pair of points are retained in superposition. Additional pairs of points can be similarly defined and processed to refine this coordinate transformation. Once the current and skeletonized first images are brought into satisfactory register, the initial translation and the secondary transformation parameters are recorded.

Once the two images are properly registered, subsequent processing is performed according to the requirements of the experiment. The current image can be used to segment the first image. One operating mode included in this embodiment uses algorithms known in the art to automatically segment the current image. In some cases, automatic segmentation of the current image does not yield acceptable results. To accommodate such cases, the current embodiment provides a tool that allows the automatically determined segmentation boundaries to be manually edited and a tool that allows segmentation boundaries to be manually drawn by, in effect, tracing features in the current image. The segmentation boundaries, however established, along with codes identifying each segmentation region are stored for later use.

The segmentation boundaries can be applied to the previously stored masked image, thus dividing it into discrete regions that can be independently quantitated or analyzed. As all of the images generated in the procedure described are in register, the results of the various measurements and analyses performed on these images can then be automatically or manually correlated with a high degree of confidence.

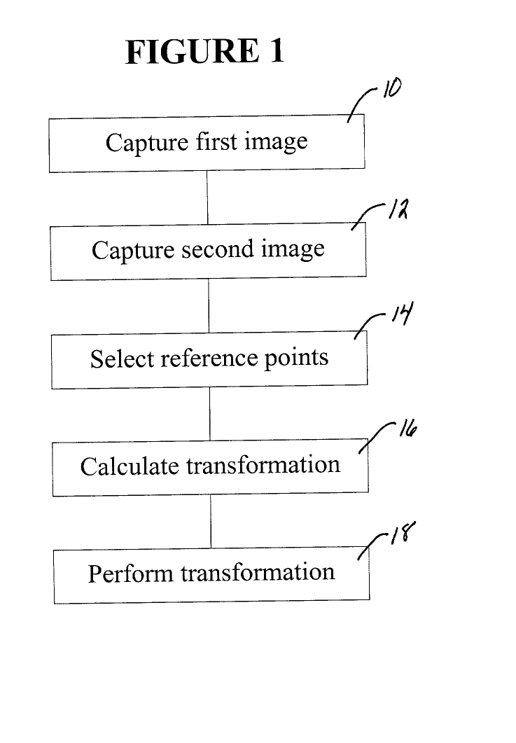

A number of process steps, including a variety of optional steps have been described herein. FIGS. 1-4 graphically illustrate in particular how these steps can be combined to practice the invention.

FIG. 1 broadly illustrates the invention. At step 10, a first image is captured, followed by capturing a second image at step 12. Reference points are selected at step 14 for the purposes of calculating a transformation at step 16. At step 18, the transformation is performed, resulting in an alignment between the first and second images.

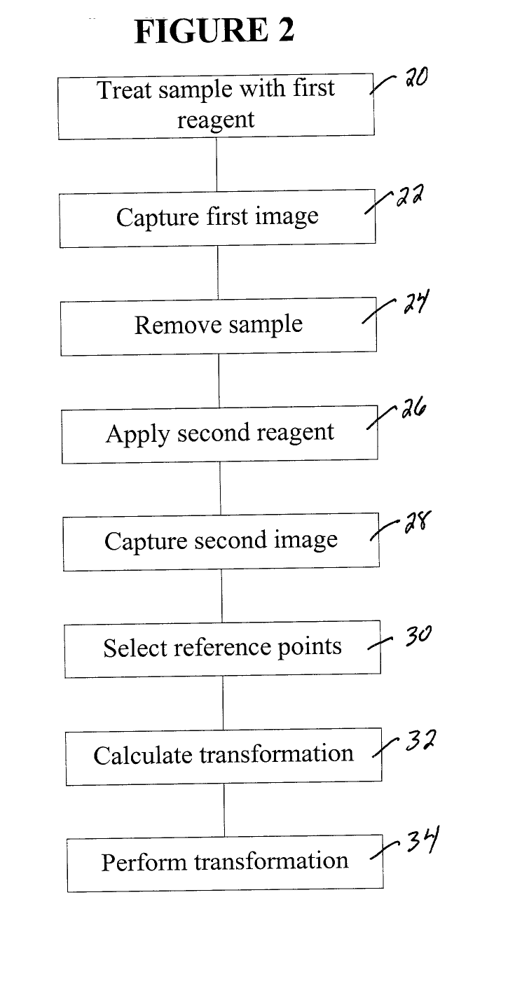

FIG. 2 illustrates an embodiment of the invention. A sample is treated with a first reagent at step 20, followed by capturing a first image at step 22. The sample is removed from the microscope at step 24 so that a second reagent can be applied at step 26. The sample is returned to the microscope and a second image is captured at step 28. Reference points are selected at step 30 so that a transformation can be calculated at step 32. The transformation is carried out at step 34, resulting in the first and second images being aligned.

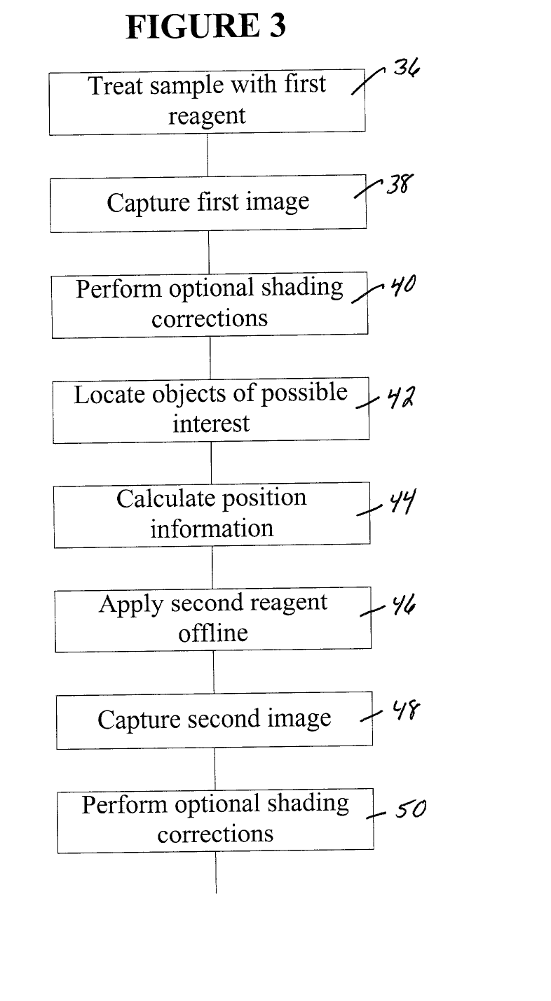

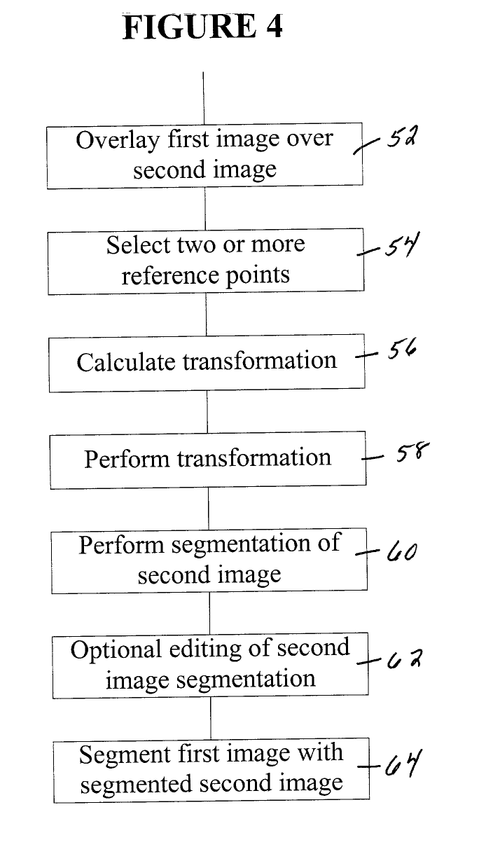

FIGS. 3 and 4 illustrate an embodiment of the invention. A sample is treated with a first reagent at step 36 and a first image is captured at step 38. Optional shading corrections can be performed at step 40, followed by locating objects of possible interest at step 42. Position information for the objects of possible interest can be calculated at step 44. A second reagent is applied offline at step 46, followed by capturing a second image at step 48. Optional shading corrections can be carried out at step 50.

At step 52 (see FIG. 4), the first image can be overlaid over the second image. Two or more reference points can be selected at step 54 for the purposes of calculating a transformation at step 56. Once the transformation has taken place at step 58, the second image can be segmented at step 60 to form a segmented second image and can optionally be edited at step 62. The first image can be segmented with the segmented second image at step 64.

While the invention has been described with reference to specific embodiments, it will be apparent to those skilled in the art that many alternatives, modifications and variations may be made. Accordingly, the present invention is intended to embrace all such alternatives, modifications and variations that may fall within the spirit and scope of the claims appended hereto.

We claim:

1. A method of correlating a first microscope observation with a second microscope observation, comprising steps of:
capturing the first microscope observation to form a first image;
capturing the second microscope observation to form a second image;
selecting two or more points on the first image and two or more corresponding points on the second image;
calculating a transformation based on the selected points to align the first and second images; and
transforming the second image to align the first image with the second image.

2. The method of claim 1, wherein a user selects the two or more points on the first image and locates the two or more corresponding points on the second image.

3. The method of claim 1, further comprising a step of performing shading corrections on the first image.

4. The method of claim 1, further comprising a step of locating possible objects of interest in the first image.

5. The method of claim 4, further comprising a step of calculating centroid information for the possible objects of interest.

6. The method of claim 4, further comprising a step of skeletonizing each possible object of interest.

7. The method of claim 1, further comprising a step of performing shading corrections on the second image.

8. The method of claim 1, further comprising a step of segmenting the second image to form a segmented second image.

9. The method of claim 8, further comprising a step of segmenting the first image in accordance with the segmented second image.

10. The method of claim 1, wherein the first microscope observation and the second microscope observation each comprise viewing a cervical cell sample.

11. The method of claim 10, wherein the cervical cell sample has been treated with an immunofluorescence reagent.

12. The method of claim 11, wherein the immunofluorescence reagent is selected to identify a cellular feature.

13. The method of claim 11, wherein the cervical cell sample has subsequently been treated with a counterstaining reagent.

14. The method of claim 13, wherein the counterstaining reagent is selected to identify cellular objects.

15. The method of claim 1, further comprising a thresholding step in which pixels below a threshold level are set equal to zero.

16. The method of claim 15, wherein pixels at or above the threshold level are set equal to one.

17. A process for examining cervical cell samples, the process comprising steps of:
providing a cervical sample on a microscope slide, the cervical sample bearing a first reagent;
placing the microscope slide on a microscope;
capturing a first image of the cervical sample;
removing the cervical sample from the microscope to provide a second reagent;
replacing the cervical sample on the microscope;
capturing a second image of the cervical sample; and
reconciling the first and second images.

18. The process of claim 17, wherein the step of reconciling the first and second images comprises:
selecting two or more points on the first image and two or more corresponding points on the second image;
calculating a transformation based on the selected points to align the first and second images; and
transforming the second image to align the first image with the second image.

19. The process of claim 17, further comprising steps of:
segmenting the second image to form a segmented second image; and
using the segmented second image to segment the first image.

20. The process of claim 18, wherein a user selects the two or more points on the first image and locates the two or more corresponding points on the second image.

21. The process of claim 17, wherein the step of providing a cervical sample on a microscope comprises providing a cervical sample bearing an immunofluorescent reagent.

22. The process of claim 17, wherein the step of removing the cervical sample from the microscope to provide a second reagent comprises adding a counterstaining reagent.

23. The process of claim 17, further comprising a step of performing shading corrections on the first image.

24. The process of claim 17, further comprising a step of locating possible objects of interest in the first image.

25. The process of claim 24, further comprising a step of calculating centroid information for the possible objects of interest.

26. The process of claim 24, further comprising a step of skeletonizing each possible object of interest.

27. The process of claim 17, further comprising a step of performing shading corrections on the second image.

28. The process of claim 17, further comprising a step of segmenting the second image to form a segmented second image.

29. The process of claim 28, further comprising a step of segmenting the first image in accordance with the segmented second image.

30. The process of claim 17, further comprising a thresholding step in which pixels below a threshold level are set equal to zero.

31. The process of claim 30, wherein pixels at or above the threshold level are set equal to one.
